(19) United States
(12) Patent Application Publication
(10) Pub. No.: US 2006/0255519 A1
(43) Pub. Date: Nov. 16, 2006

(54) Clamping holder

(76) Inventor: Zbigniew Noniewicz, Kempenich (DE)

Correspondence Address: EVEREST INTELLECTUAL PROPERTY LAW GROUP, P. O. BOX 708, NORTHBROOK, IL, 60065, US

(21) Appl. No.: 11/387,451

(22) Filed: Mar. 23, 2006

(30) Foreign Application Priority Data
Jan. 4, 2005 (DE) 102005015336.4
Mar. 3, 2006 (DE) 102006010383.1

(51) Int. Cl. B25B 1/00

(52) U.S. Cl. 269/6

(57) ABSTRACT

A clamping holder with a housing having a fixed clamping jaw, a push/pull bar through the housing and a movable clamping jaw. Spacings (A) of the free ends of a gripping handle and of a drive lever from the push/pull bar being approximately equal. Contour lines of the backs of the gripping handle and the drive lever being convexly rounded along the direction of their extent and respectively running on imaginary arcuate lines. The contour lines extend radially outward over the entire gripping zone up to the free ends and, in the region of the free ends, leave the imaginary arcuate lines toward their center points. The length of the radii of the arcuate lines being at least 70% of the spacing (A) and at most 200% of the spacing (A).

### BACKGROUND OF THE INVENTION

The invention relates to, a clamping holder. In an embodiment, the invention relates to a clamping holder with a housing, through which a push/pull bar reaches, with a fixed clamping jaw, which is fixedly disposed on the housing on one side of the push/pull bar, and a movable clamping jaw, which is mounted on the push/pull bar and can be displaced with respect to the fixed clamping jaw by a drive mechanism disposed in the housing by pivoting of a drive lever, which is disposed on the housing together with the gripping handle, fixed to the housing, on the other side of the push/pull bar, the spacings of the free ends of the gripping handle and of the drive lever from the push/pull bar being approximately equal and the contour lines of the backs, facing away from each other, of the gripping handle and of the drive lever being convexly rounded along the direction of their extent and respectively running on an imaginary arcuate line.

U.S. Pat. No. 6,676,120 B1 describes a clamping holder in which the gripping handle and the drive lever are of approximately the same length. The free ends have the same spacing from the push/pull bar. In the region which is grasped by the user's hand, that is the gripping zone, the backs facing away from each other of the gripping handle and of the drive lever respectively run on an arcuate line. The two arcuate lines run on very different radii. The arcuate line which defines the shape of the back of the drive lever runs on an arcuate line of a radius which corresponds to approximately twice the length of the drive lever. The radius of the back of the gripping handle runs on an arcuate line of a radius which corresponds approximately to three times the length of the drive lever. The user's hand must not exceed a certain size. The width of the hand must be less than the spacing between a projection of the end of the gripping handle or of the drive lever and an abutment shoulder on the fixed side of the grip or gripping handle.

A one-handed clamping holder is also disclosed by DE 197 31 579.

### SUMMARY OF THE INVENTION

An advantage of the invention can be to improve ergonomically the actuating elements, that is the drive lever and the gripping handle, of a one-handed clamping holder.

The advantage can be achieved by the invention specified in the claims, each claim representing in principle an independent solution and it being possible for each claim to be combined with any other claim.

Embodiments of the invention improve the known clamping holder with respect to its handling. The handling is ergonomically better. For this purpose, in an embodiment it is provided that the backs facing away from each other of the gripping handle and of the drive lever are convexly rounded in such a way that the arcuate lines form delimiting lines, beyond which the contour line does not extend radially outward over the entire gripping zone. Over the entire gripping zone up to the free ends of the gripping handle and of the drive lever, the contour line runs in a region which is delimited radially outward by the arcuate lines. The contour line leaves the imaginary arcuate line only in the end regions of the gripping handle and of the drive lever. The contour line curves more at those locations. It leaves the arcuate line heading toward its center point. The consequently pointed free ends of the contour line of the gripping handle and the contour line of the drive lever lie in the region of the arcuate lines. As a result, the palm of the user's hand can also be supported on the regions of the free ends of both the gripping handle and the drive lever. The fingers of the hand grasping either the drive lever or the gripping handle, depending on the gripping direction, then lie on the regions of the backs that follow the arcuate line. Unlike in the case of the generic prior art, the backs of both the gripping handle and the drive lever are more curved. As a result, the user's gripping hold can be varied to a considerably greater extent than in the case of the prior art, where the radially outwardly protruding projections in the region of the ends of the drive lever and of the gripping handle are additionally troublesome. The gripping handle and the drive lever are not only rounded in the respective direction of their extent. The gripping handle and the drive lever are preferably also rounded transversely to the direction of their extent. This rounding, however, has a considerably greater curvature than the rounding in the direction of their extent. The gripping handle and the drive lever have a similar shape. They each form backs, the contour of the curvature of which preferably lies in each case on an arcuate line. The imaginary arcuate lines have virtually the same radius of curvature. The radius of curvature of the gripping handle, which lies in the palm of a user's hand, is rounded somewhat less than the back of the drive lever around which the fingers of the user's hand grip. The two backs are spaced apart from each other in such a way that the user's hand can comfortably grasp the gripping handle and the drive lever. A release lever disposed in front of the handle is shorter. It has a length which is adequate for the release lever to be grasped with the index finger. For this purpose, it also has a corresponding spacing from the gripping handle. The end of the gripping handle facing the push/pull bar also forms a bead, against which the curve between the thumb and the index finger of the user's hand lies. However, it is also possible to actuate the clamping holder the other way round, in that the drive lever lies with its back in the palm of the user's hand and the fingers of the user's hand grasp the gripping handle. Since the two arcuate lines have similar radii, ergonomic handling is also possible when it is actuated in this way. In a development of the invention, it is provided that the gripping handle and the drive lever are disposed with a certain symmetry in relation to each other. The gripping handle and the drive lever form a space between them. A line of symmetry runs as an angle bisector through this space and intersects a vertex. The arcs of the curvatures are preferably disposed in such a way that they intersect approximately at the line of symmetry. This line of symmetry runs transversely to the direction of the extent of the push/pull bar. The two center points of the lines of curvature on which the backs of both the drive lever and the gripping lever run lie on a line which extends substantially parallel to the push/pull bar. The radii are of the same order of magnitude as the lengths of the gripping lever and the drive lever. The inner flanks of the gripping lever and of the drive lever, which face each other, are also rounded. However, they are less rounded than their backs.

In a development of the invention it is provided that the drive lever and the release lever are associated with the driving body in a clipping manner. For this purpose, the drive housing has a bearing portion, which forms a journal on each of both the wide sides. The drive lever can be clipped by means of this journal. The release lever is clipped in the same way by means of a journal associated with it. For this purpose, the lever forms a slot. Within the slot there is a region which forms two opposite run-on slopes. This region is pushed over the journals until the journals engage in bearing openings which are located at the end of the run-on slopes. By being configured in this way, the one-handed clamping holder can be easily assembled. Special spindles, in particular push-in spindles, are not required. The respective ends of the release lever and of the drive lever that protrude into the housing also act directly on the drive mechanism. The release lever and the drive lever are consequently injection-molded from the same plastics material throughout. The housing can also be produced as an injection-molded part. Just a central opening, which receives the elements of the drive mechanism, is provided with housing coverings.

Additional features and advanatages of the present invention are described in, and will be apparent from, the following Detailed Description of the Invention and the figures.

### BRIEF DESCRIPTION OF THE FIGURES

An exemplary embodiment of the invention is explained below on the basis of accompanying drawings, in which:

FIG. 1 shows the representation of a one-handed clamping holder in the assembled state,

FIG. 2 shows a representation according to FIG. 1 with the housing covering removed,

FIG. 3 shows a representation according to FIG. 2 with the drive lever actuated,

FIG. 4 shows a representation according to FIG. 2 with the release lever actuated,

FIG. 5 shows a representation according to FIG. 3 with a user's hand to illustrate the relative sizes of the drive lever, the gripping handle and the release lever,

FIG. 6 shows a representation according to FIG. 2 with arcs depicted as dash-dotted arc lines to illustrate the shape of the backs 7′, 8′ of the gripping handle 7 and of the drive lever 8, respectively,

FIG. 7 shows a representation of the drive housing as an injection-molded part of the same material throughout,

FIG. 8 shows a section along the line VIII-VIII in FIG. 7, FIG. 9 shows a drive lever in a perspective representation viewed from below,

FIG. 10 shows a longitudinal center section through the slot 27 of the drive lever 8 and

FIG. 11 shows a section along the line XI-XI in FIG. 2.

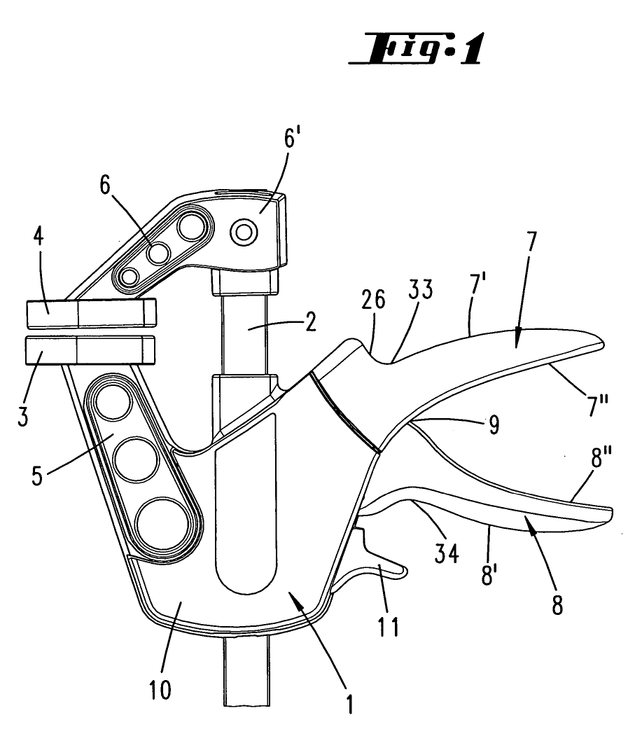

### DETAILED DESCRIPTION OF THE INVENTION

The one-handed clamping holder described in the exemplary embodiment has a drive housing 1 comprising a single injection-molded part. The drive housing 1 has a well-shaped through-opening for receiving a cross-sectionally square push/pull bar 2 consisting of metal. On one side of the push/pull bar 2 there is a fixed jaw 3, which is firmly connected to the drive housing 1 by means of a jaw carrier 5.

Opposite the fixed jaw 3 there is a movable jaw 4, which is associated with a further jaw carrier 6, on the head 7 of which the end of the push/pull bar 2 is releasably mounted.

On the side opposite from the jaws 3, 4, the housing has a gripping handle 7, which protrudes substantially at right angles, the back 7′ of which is rounded and which lies opposite a drive lever 8, which likewise has a rounded back 8′, but which extends away from the back 7′ of the gripping handle. The rounding of both the back 7′ of the gripping handle 7 and the back 8′ of the drive lever 8 run in the direction of the extent of the gripping handle 7 and of the drive lever 8, respectively. In addition, the drive lever 8 and the gripping handle 7 are, however, also rounded in the transverse direction, so that the zone thereof that is grasped by the hand or the fingers is convex.

The drive housing 1 has inside two clear windows, which are closed on both sides by a housing covering 10. In a window facing the movable jaw 4, a drive plate 15, through which the push/pull bar 2 passes and which is acted upon by a restoring spring 16, lies against an abutment face 19, which extends transversely to the direction of extent of the push/pull bar 2. On a side opposite from the restoring spring 16, a drive cam 14 of the drive lever 8 engages against the drive plate 15. If the drive lever 8 pivots, the opening in which the push/pull bar 2 lies with the narrow sides of the push/pull bar tilts, so that pivoting of the drive lever 8 results in a linear displacement of the push/pull bar 2 in such a way that the two jaws 3, 4 are moved toward each other. However, the tool may also be used as a spreading holder. Then the jaws 3, 4 are moved step by step away from each other.

In the other window, a blocking plate 17 lies in a pivotally movable manner and is acted upon from one side by a blocking plate spring 18 into a tilting position. The end of the blocking plate 17 opposite from the blocking plate spring 18 lies in a C-shaped bearing mouth 20.

On the wide side of the blocking plate 17 opposite from the blocking plate spring 18, a triggering cam 22 of a release lever 11 may act. Like the drive lever 8, the release lever 11 is produced as an injection-molded part and can be actuated by the index finger of a hand grasping the gripping handle 7 and the drive lever 8.

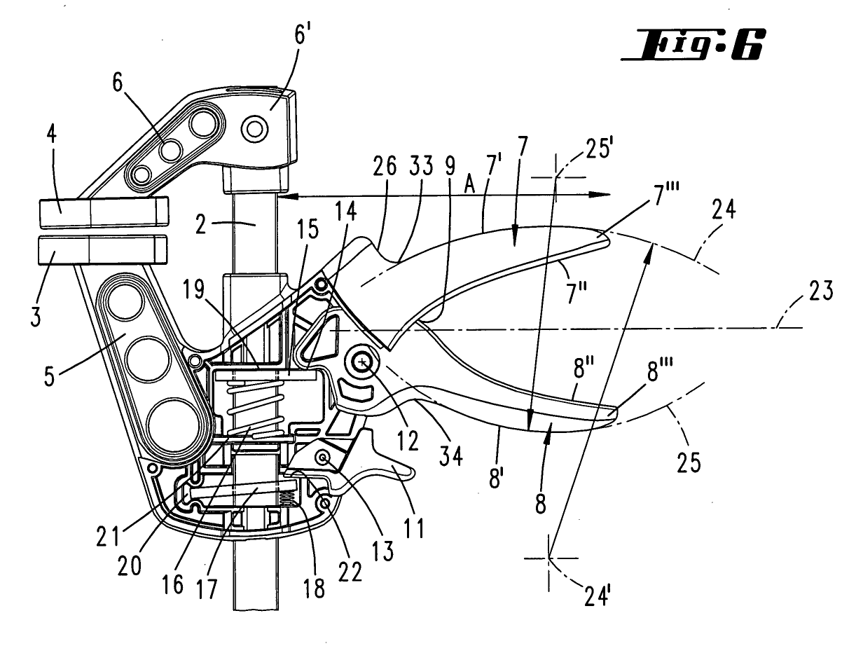

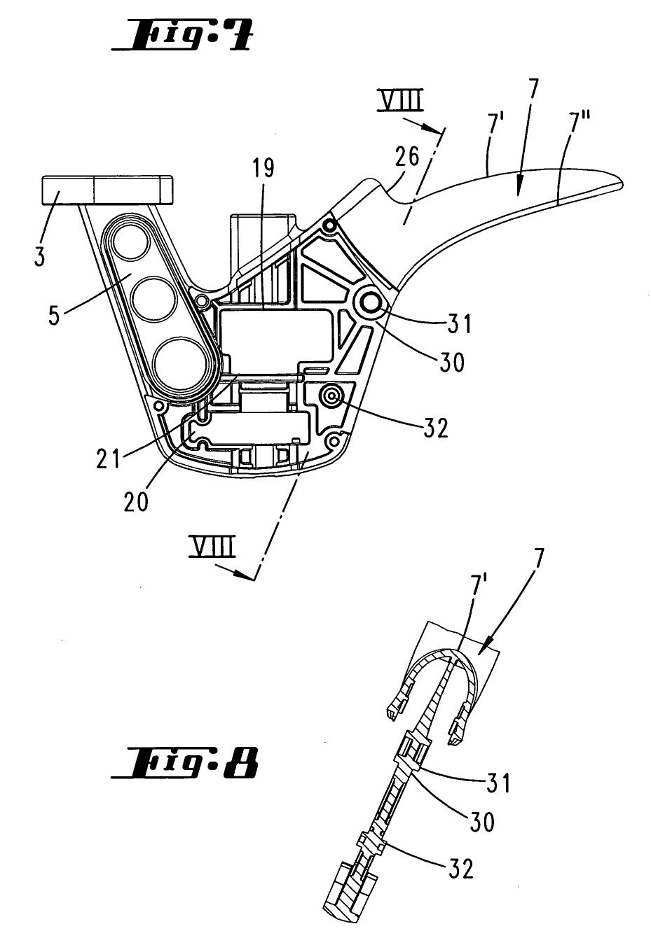

As can be gathered from FIG. 7, the injection-molded part forming the drive housing 1 forms two opposite journals 31 in a bearing portion 30. Journals 32 are also provided for the mounting of the release lever 11.

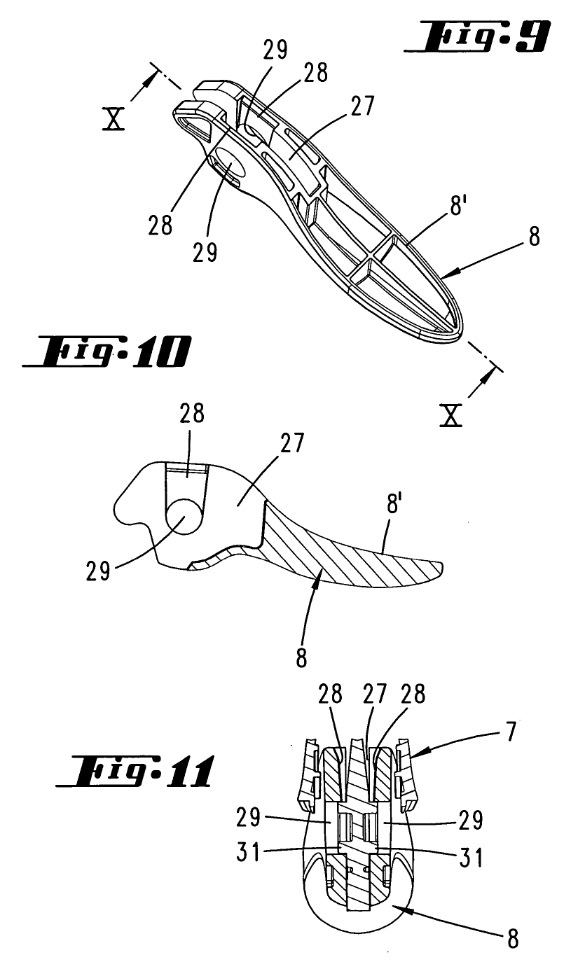

As FIGS. 9 to 11 reveal, the drive lever 8, produced from an injection-molded part, forms in the region of its bearing a slot 27, which in one region forms two opposite walls of a well-like opening, which run obliquely toward each other. These regions form run-on slopes 28. The run-on slopes 28 end in bearing openings 29, which lie in line with each other and serve for receiving the journals 31.

The mounting of the drive lever and the release lever takes place as follows.

The bearing portion 30 is inserted into the slot 27 in such a way that the run-on slopes 28 run on the two opposite journals 31. By exerting force, the two walls of the slot then spread apart, until the two journals 31 snap into the bearing openings 29 respectively associated with them. The mounting of the release lever 11 takes place in the same way.

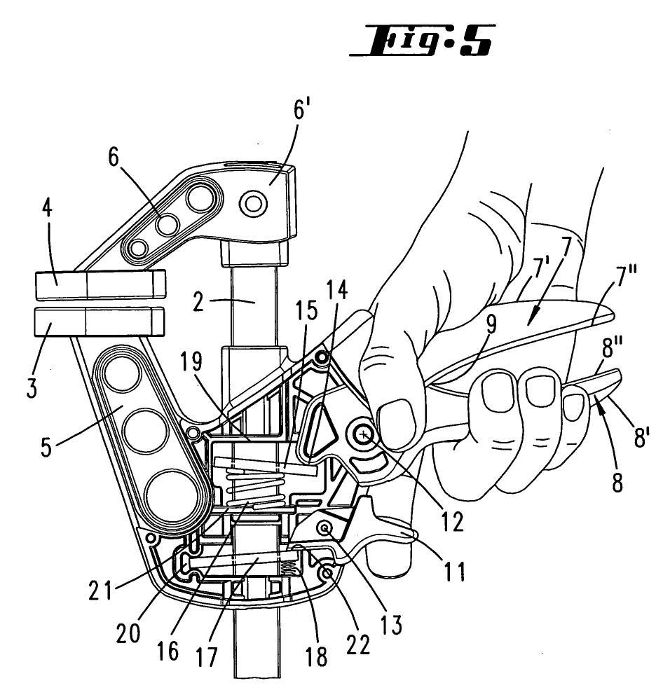

The geometrical shaping of the gripping handle 7 and of the drive lever 8 can be gathered from FIG. 6. The gripping handle 7 and the drive lever 8 protrude substantially transversely from the push/pull bar 2 in such a way that a line of symmetry 23 lying in the intermediate space between the gripping handle 7 and the drive lever 8 extends approximately transversely to the direction of the extent of the push/pull bar 2. The line of symmetry runs through a vertex 9, which is formed by the two opposite inner flanks 7″ and 8″ of the gripping handle 7 and of the drive lever 8.

The two backs 7′ and 8′, respectively facing away from each other, of the gripping handle 7 and of the drive lever 8 run on the arcuate lines 24, 25, represented by dash-dotted lines. The two arcuate lines intersect approximately in the region of the angle bisector 23. The center points of the accurate lines 24, 25, designated by 24′ and 25′, respectively, lie on an imaginary line which runs parallel to the push/pull bar 2.

The spacing A of the free end 7′″ of the gripping handle 7 from the push/pull bar corresponds approximately to 120 mm and is approximately equivalent to the radius of the arcuate line 24 on which the back 7′ runs. In the exemplary embodiment, this radius corresponds to approximately 140 mm. The radius of the arcuate line 25 on which the back 8′ of the drive lever 8 runs is somewhat smaller. It is 100 mm. The spacing A of the free end 8′″ of the drive lever 8 is likewise 120 mm. The radii of the arcuate lines 24, 25 preferably lie in a range between 80 and 160 mm, preferably in a range between 90 and 150 mm. It is advantageous if the radius of curvature of the gripping handle 7 lying in the palm of the hand of a user is somewhat greater than that of the drive lever 8 grasped by the fingers of the hand. The two center points 24′, 25′, however, always lie on the far side of the turned-away back, so that the greatest spacing of the two backs 7′, 8′ facing away from each other is less than the smallest radius.

In the region of the free ends 7′″ and 8′″, the back 7′ or 8′ runs on a rather more curved contour line. This rather more curved contour line respectively goes over into an inner flank 7″, 8″, forming a rounded tip. In this case, the rounded tip formed in this way of the end portions 7′″, 8′″ lies within the two contour lines 24, 25. There are therefore no outwardly protruding projections. The free ends 7′″, 8′″ can lie in the palm of the user's hand, depending on the gripping direction of the user, so that the lever action is increased.

As FIG. 6 further reveals, an abutment shoulder 26 for the curve between the thumb and index finger of the user's hand lies approximately on the imaginary line prolonging the inner flank 8″ of the drive lever 8. Like the inner flank 7″, the inner flank 8″ runs on a curved line.

The spacing of the release lever 11 from the abutment shoulder 26, which is rounded, is dimensioned in such a way that, with a holding hand grasping the gripping handle 7 and the drive lever 8, the release lever 11 can be actuated by the index finger.

The release lever 11 is disposed in such a way that it can be grasped by the tip of the index finger of the hand reaching around the grip and the release lever.

The zone of the release lever 11 grasped by the index finger is rounded transversely to the direction of extent of the release lever 11. In the direction of extent, the release lever is substantially concavely rounded.

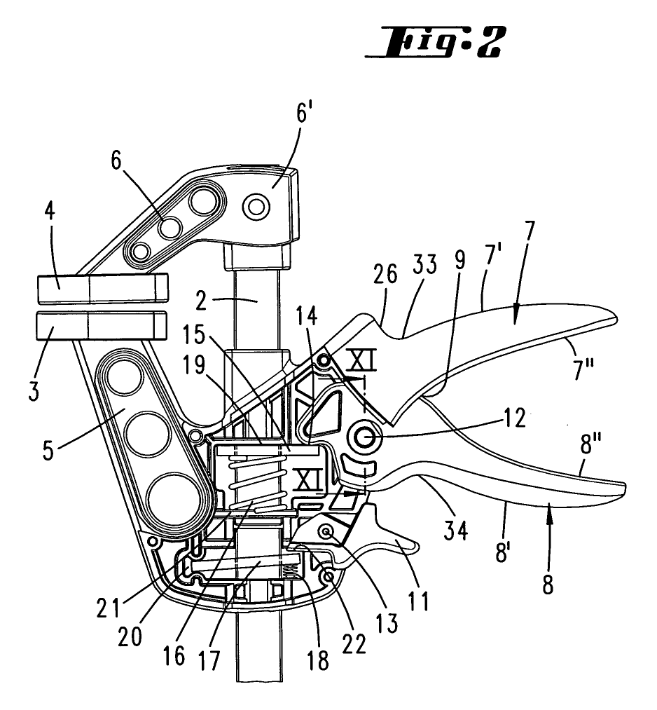

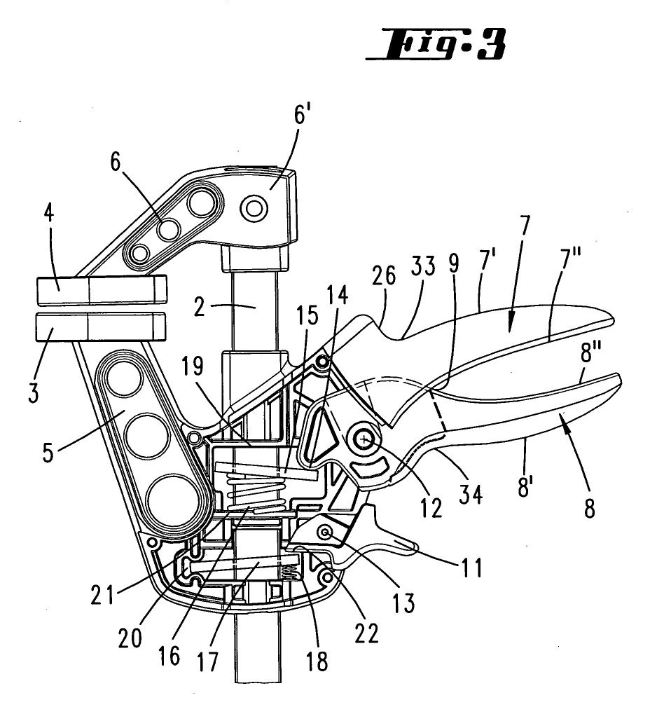

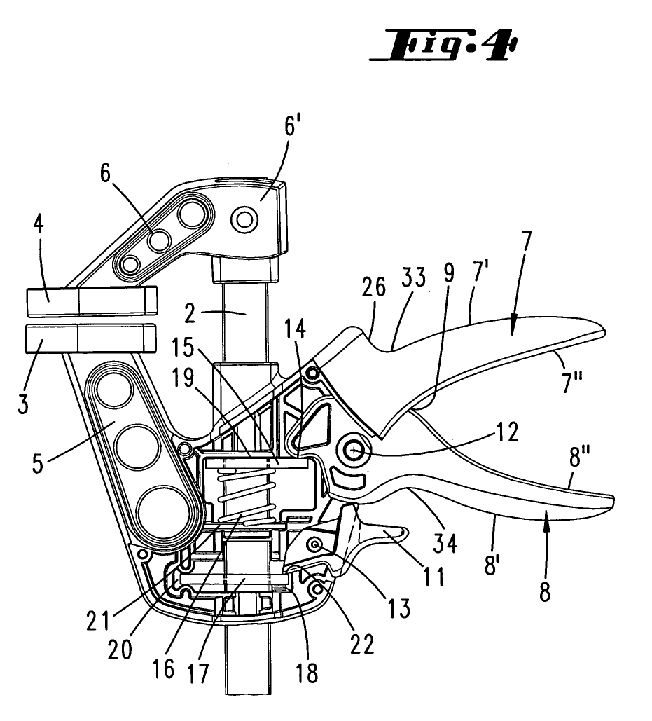

As the figures further reveal, beginning from the outer ends of the gripping handle 7 and of the drive lever 8, the convexly rounded backs 7′, 8′ of the gripping handle 7 and of the drive lever 8 extend over the region that is substantially grasped by the hand or the fingers. Both the back 7′ and the back 8′ respectively go over at the end of the grasped zone into a concavely rounded gripping zone. The concavely rounded gripping zone is more curved than the convexly rounded gripping zone. In the case of the gripping handle 7, the concavely rounded gripping zone goes over into the bead 26 and supports the curve between the middle finger and the index finger. Here, the gripping contour forms a saddle, since here, too, the grip is convexly rounded in the transverse direction. The drive lever 8 also forms a saddle in the region of its convexly curved portion. This saddle lies directly opposite the saddle formed by the gripping handle 7. In FIG. 2, the two saddles are designated by the reference numerals 33 and 34. The straight line running through the center points 24′ and 25′, parallel to the direction of extent of the push/pull bar 2, intersect the gripping handle 7 and the drive lever 8, respectively, near their free ends. The spacing between the point of intersection of these straight lines and the respective free end of the gripping handle 7 or of the drive lever 8 corresponds approximately to one quarter of the spacing of the point of intersection of the straight lines from the saddle 33 or 34, respectively.

All disclosed features are (in themselves) pertinent to the invention. The disclosure content of the associated/accompanying priority documents (copy of the prior application) is also hereby incorporated in full in the disclosure of the application, including for the purpose of incorporating features of these documents in claims of the present application.

It should be understood that various changes and modifications to the presently preferred embodiments described herein will be apparent to those skilled in the art. Such changes and modifications can be made without departing fron the spirit and scope of the present invention. It is therefore intended that such changes and modifications be covered by the appended claims.

1-12. (canceled)

13. A clamping holder, comprising:
a housing;
a push/pull bar extending through the housing;
a fixed clamping jaw fixedly disposed on the housing on one side of the push/pull bar;
a movable clamping jaw mounted on the push/pull bar and displacable with respect to the fixed clamping jaw;
a drive mechanism disposed in the housing which displaces the movable clamping jaw by pivoting of a drive lever disposed on the housing relative to a gripping handle fixed to the housing on the other side of the push/pull bar;
spacings (A) of free ends of the gripping handle and of the drive lever from the push/pull bar being approximately equal; and
contour lines of backs, facing away from each other, of the gripping handle and the drive lever being convexly rounded along a direction of their extent and respectively running on imaginary arcuate lines;
wherein the contour lines are delimited radially outward over entire gripping zones up to the free ends by the arcuate lines and, in the region of the free ends, leave the imaginary arcuate lines toward center points of the imaginary arcuate lines; and
wherein lengths of radii of the arcuate lines being at least 70% of the spacing (A) and at most 200% of the spacing (A).

14. The clamping holder according to claim 13, wherein end tips of the free ends, formed by inner flanks of the gripping handle and the drive lever, respectively, with the grip backs, lie within the arcuate lines.

15. The clamping holder according to claim 13, wherein a line of symmetry runs substantially through a vertex formed by inner flanks facing each other of the gripping handle and the drive lever.

16. The clamping holder according to claim 13, wherein the radii of curvature of the two arcuate lines are substantially equal or differ only a little.

17. The clamping holder according to claim 13, wherein the lengths of the radii of the arcuate lines correspond approximately to a length of the gripping handle and a length of the drive lever.

18. The clamping holder according to claim 13, wherein the center points of the arcuate lines lie on an imaginary line which extends parallel to the push/pull bar.

19. The clamping holder according to claim 13, wherein inner flanks of the gripping handle and the drive lever are less curved than the backs.

20. The clamping holder according to claim 13, wherein radii of curvature of the gripping handle and the drive lever are approximately as great as or slightly greater than the width of a hand.

21. The clamping holder according to claim 13, wherein the radii of the arcuate lines range about 80-160 mm.

22. The clamping holder according to claim 21, wherein the spacing (A) is approximately 120 mm.

23. The clamping holder according to claim 13, wherein the radii of the arcuate lines range about 90-150 mm.

24. The clamping holder according to claim 23, wherein the spacing (A) is approximately 120 mm.

25. The clamping holder according to claim 13, wherein the radii of the arcuate lines range about 100-140 mm.

26. The clamping holder according to claim 25, wherein the spacing (A) is approximately 120 mm.

27. A clamping holder, comprising:
a housing;
a push/pull bar extending through the housing;
a fixed clamping jaw fixedly disposed on the housing on one side of the push/pull bar;
a movable clamping jaw mounted on the push/pull bar and displacable step by step against a pushing-back inhibitor;
a drive mechanism disposed in the housing which displaces the movable clamping jaw by pivoting of a drive lever disposed on the housing relative to a gripping handle fixed to the housing on the other side of the push/pull bar; and
a release lever which releases the pushing-back inhibitor;
wherein the drive lever and the release lever are clipped on journals of the housing.

28. The clamping holder according to claim 27, wherein the journals are molded onto the housing.

29. The clamping holder according to claim 27, wherein the release lever and the drive lever consist of plastic and form a slot with opposite run-on slopes, the run-on slopes ending in bearing openings.
